(19) United States
(12) Patent Application Publication
(10) Pub. No.: US 2003/0157951 A1
(43) Pub. Date: Aug. 21, 2003

(54) System and method for routing 802.11 data traffic across channels to increase ad-hoc network capacity

(76) Inventor: William V. Hasty JR., Longwood, FL (US)

Correspondence Address: Ronald S. Grubb, Roylance, Abrams, Berdo & Goodman, L.L.P., 1300 19th Street, N.W., Suite 600, Washington, DC, 20036, US

(21) Appl. No.: 10/368,608

(22) Filed: Feb. 20, 2003

Related U.S. Application Data
(60) Provisional application No. 60/357,630, filed on Feb. 20, 2002.

(51) Int. Cl. H04Q 7/20

(52) U.S. Cl. 455/519; 455/41

(57) ABSTRACT

A system and method for data transmission incorporating a channel bridge node which can identify and deliver data traffic requiring delivery via alternate 802.11 data channels. The system and method provides a channel bridging node which is configured to communicate via each channel of the available spectrum in series. The node advertises this capability and accepts data traffic for communication over any number of channels. Data is buffered for subsequent delivery once the node is configured to communicate via the channel to which the data is addressed. In doing so, the system and method provides a channel bridge which enables routing of 802.11 data traffic across channels in 802.11 ad-hoc networks, thus increasing ad-hoc network capacity.

This application claims benefit under 35 U.S.C. §119(e) from U.S. provisional patent application serial No. 60/357,630 entitled “A System And Method For Routing 802.11 Data Traffic Across Channels To Increase Ad-Hoc Network Capacity”, filed Feb. 20, 2002, the entire contents of which is incorporated herein by reference.

### BACKGROUND OF THE INVENTION

1. Field of the Invention

The present invention relates to a system and method for improving channel use in 802.11 ad-hoc networks in order to increase ad-hoc network capacity. More particularly, the present invention relates to a system and method for providing a channel bridge which enables routing of 802.11 data traffic across channels in 802.11 ad-hoc networks in order to increase ad-hoc network capacity.

2. Description of the Related Art

In recent years, a type of mobile communications network known as an “ad-hoc” network has been developed for use by the military. In this type of network, each user terminal (hereinafter “mobile node”) is capable of operating as a base station or router for the other mobile nodes, thereby eliminating the need for a fixed infrastructure of base stations. Accordingly, data packets being sent from a source mobile node to a destination mobile node are typically routed through a number of intermediate nodes before reaching the destination node. Details of an ad-hoc network are set forth in U.S. Pat. No. 5,943,322 to Mayor, the entire content of which is incorporated herein by reference.

More sophisticated ad-hoc networks are also being developed which, in addition to enabling mobile nodes to communicate with each other as in a conventional ad-hoc network, further enable the mobile nodes to access a fixed network and communicate with other types of user terminals, such as those on the public switched telephone network (PSTN) and on other networks such as the Internet. Details of these types of ad-hoc networks are described in U.S. patent application Ser. No. 09/897,790 entitled “Ad Hoc Peer-to-Peer Mobile Radio Access System Interfaced to the PSTN and Cellular Networks”, filed on Jun. 29, 2001, in U.S. patent application Ser. No. 09/815,157 entitled “Time Division Protocol for an Ad-Hoc, Peer-to-Peer Radio Network Having Coordinating Channel Access to Shared Parallel Data Channels with Separate Reservation Channel”, filed on Mar. 22, 2001, and in U.S. patent application Ser. No. 09/815,164 entitled “Prioritized-Routing for an Ad-Hoc, Peer-to-Peer, Mobile Radio Access System”, filed on Mar. 22, 2001, the entire content of each patent application being incorporated herein by reference.

In these types of ad-hoc networks, as well as in other communication networks, terminals typically communicate with each other over channels and are often adapted to comply with a family of IEEE standards known as the 802.11 standards. The 802.11-1999 published standard, the entire content of which is incorporated herein by reference, defines a channel as an instance of medium use for the purpose of passing protocol data units (PDU). A single channel may be used simultaneously, in the same volume of space, with other instances of medium use (additional channels) by other instances of the same physical layer (PHY), with an acceptably low frame error ratio due to mutual interference. Some PHYs provide only one channel, whereas others provide multiple channels.

As can be appreciated by one skilled in the art, all 802.11 radio standards employ multiple channels. Specifically, the 802.11 specification allows radios to use 11 channels to form networks, but does not specify how a channel is to be selected. As described in a text by Rob Flickenger, entitled “Building Wireless Community Networks Implementing the Wireless Web”, the entire content of which is incorporated herein by reference, the specification 802.11 breaks the available spectrum into 11 overlapping channels, as shown below,

| channel | frequency (GHz) |
|---|---|
| 1 | 2.412 |
| 2 | 2.417 |
| 3 | 2.422 |
| 4 | 2.427 |
| 5 | 2.432 |
| 6 | 2.437 |
| 7 | 2.442 |
| 8 | 2.447 |
| 9 | 2.452 |
| 10 | 2.457 |
| 11 | 2.462 |

As further detailed in the Flickenger text, the channels are spread spectrum and actually use 22 MHz of signal bandwidth, so adjacent radios need to be separated by at least five channels to see zero overlap. For example, channels 1 and 6, 2 and 7, 3 and 8, 4 and 9, 5 and 10, and, 6 and 11, have no overlap between the two channels, as each are separated from the other by at least five channels. In this case, the term “channel” however, does not refer to a discrete, single frequency band. As noted in an article by Joe Bardwell, entitled “Configuration Options For AiroPeek”, the entire content of which is incorporated herein by reference, each channel in an 802.11 standard refers to a subgroup, or group of smaller, individually discrete, ranges of frequencies.

Even though there are 11 channels to choose from, only 3 channels have sufficient spreading to be considered independent of each other, including channels 1, 6 and 11. After an 802.11 network is formed on a channel, it remains on the same channel until the network is dissolved. Additionally, all 802.11 radios participating in an IBSS ad-hoc network operate on the same channel.

Currently, 802.11 ad-hoc networks span only a single channel for the life of the network. Hence, 802.11 radios operating in ad-hoc mode are typically not visible to other 802.11 radios which are operating on separate channels. In the absence of auxiliary non-802.11 communications channels (such as an Ethernet), stations in 802.11 ad-hoc networks cannot communicate with ad-hoc networks on other channels. Therefore, a common communication situation can occur in which radios in the ad-hoc network on channel 1 cannot communicate with radios in the ad-hoc network on channel 6.

Accordingly, a need exists for a system and method for improving channel use in 802.11 ad-hoc networks by allowing routing of 802.11 data traffic across channels in order to increase ad-hoc network capacity.

### SUMMARY OF THE INVENTION

An object of the present invention is to provide a system and method for improving channel use in 802.11 ad-hoc networks in order to increase ad-hoc network capacity.

Another object of the present invention is to provide a system and method for enabling routing of 802.11 data traffic across channels in 802.11 ad-hoc networks in order to increase ad-hoc network capacity.

Still another object of the present invention is to provide a system and method to configure a bridging node to communicate in each channel of the available spectrum in series.

Still another object of the present invention is to provide a system and method to advertise alternate channel destinations available via a bridging node in each channel of the available spectrum.

Still another object of the present invention is to receive data traffic originating in one channel and addressed for a destination via a second channel, and communicating the data traffic using a bridging node once the bridging node is configured to communicate via the destination channel.

These and other objects are substantially achieved by providing a channel bridge in an 802.11 ad-hoc network that can occupy multiple channels at least part-time, to deliver traffic across channels. The system and method provides a channel bridge node which can identify and deliver data traffic requiring delivery via alternate 802.11 data channels. The system and method provides a channel bridging node which is configured to communicate via each channel of the available spectrum in series. The node advertises this capability, in addition to destination nodes and dwell times, and accepts data traffic for communication over any number of 802.11 channels.

Received data is buffered for subsequent delivery once the node is configured to communicate via the channel to which the data is addressed. In doing so, the system and method provides a channel bridge which enables routing of 802.11 data traffic across channels in 802.11 ad-hoc networks increasing ad-hoc network capacity.

### BRIEF DESCRIPTION OF THE DRAWINGS

These and other objects, advantages and novel features of the invention will be more readily appreciated from the following detailed description when read in conjunction with the accompanying drawings, in which:

FIG. 1 is a block diagram of an example ad-hoc packet switched wireless communications network including a plurality of nodes in accordance with an embodiment of the present invention;

FIG. 2 is a block diagram illustrating an example of a mobile node employed in the network shown in FIG. 1;

FIG. 3 is a block diagram of an example of a conventional 802.11 ad-hoc network in which radios operating on one channel are unable to communicate with radios operating on another channel;

FIG. 4 is a block diagram of an 802.11 ad-hoc network employing an embodiment of the present invention which creates a channel bridge that can occupy multiple channels on at least a part-time basis to thus enable the delivery of traffic across channels; and

FIG. 5 is a flow chart illustrating an example of the operation of a channel bridge node to occupy and deliver traffic across the multiple channels of FIG. 4.

### DETAILED DESCRIPTION OF THE PREFERRED EMBODIMENTS

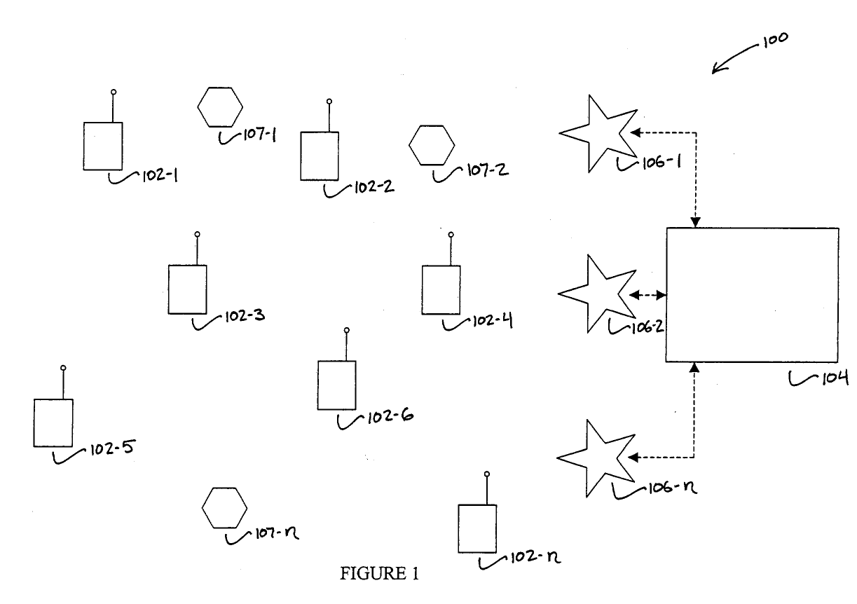

FIG. 1 is a block diagram illustrating an example of an ad-hoc packet-switched wireless communications network 100 employing an embodiment of the present invention. Specifically, the network 100 includes a plurality of mobile wireless user terminals 102-1 through 102-n (referred to generally as nodes 102 or mobile nodes 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, the public switched telephone network (PSTN) and the Internet. The network 100 further can include a plurality of fixed routers 107-1 through 107-n (referred to generally as nodes 107 or routers 107) for routing data packets between other nodes 102, 106 or 107. It is noted that for purposes of this discussion, the nodes discussed above can be collectively referred to as “nodes 102, 106 and 107”, or simply “nodes”.

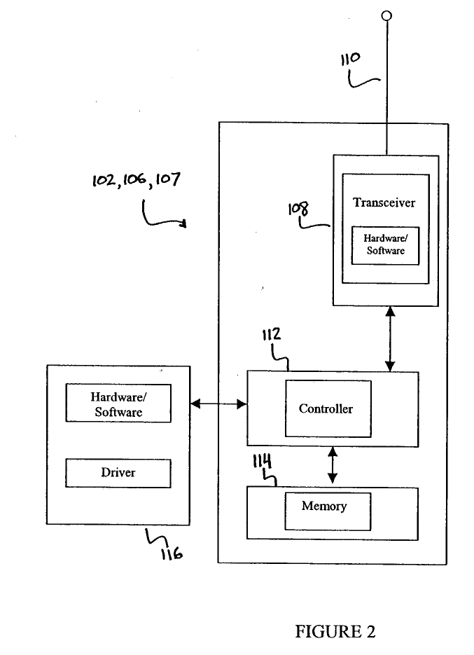

As can be appreciated by one skilled in the art, the nodes 102, 106 and 107 are capable of communicating with each other directly, or via one or more other nodes 102, 106 or 107 operating as a router or routers for packets being sent between nodes, as described in U.S. Pat. No. 5,943,322 to Mayor, referenced above. As shown in FIG. 2, each node 102, 106 and 107 includes a transceiver 108 which is coupled to an antenna 110 and is capable of receiving and transmitting signals, such as packetized data, to and from the node 102, 106 or 107, under the control of a controller 112. The packetized data signals can include, for example, voice, data or multimedia information, and packetized control signals, including node update information.

Each node 102, 106 and 107 further includes a memory 114, such as a random access memory (RAM), that is capable of storing, among other things, routing information pertaining to itself and other nodes in the network 100. The nodes periodically exchange respective routing information, referred to as routing advertisements or routing table information, via a broadcasting mechanism, for example, when a new node enters the network or when existing nodes in the network move.

As further shown in FIG. 2, certain nodes, especially mobile nodes 102, can include a host 116 which may consist of any number of devices, such as a notebook computer terminal, mobile telephone unit, mobile data unit, or any other suitable device. Each node 102, 106 and 107 also includes the appropriate hardware and software to perform Internet Protocol (IP) and Address Resolution Protocol (ARP), the purposes of which can be readily appreciated by one skilled in the art. The appropriate hardware and software to perform transmission control protocol (TCP) and user datagram protocol (UDP) may also be included. Additionally, each node includes the appropriate hardware and software to perform automatic repeat request (ARQ) functions, as set forth in greater detail below. Also, certain nodes which can function as channel bridges, include a network protocol that allows each to exist in multiple networks on a time division basis. Traffic destined to be bridged is buffered at the bridge and at adjacent nodes.

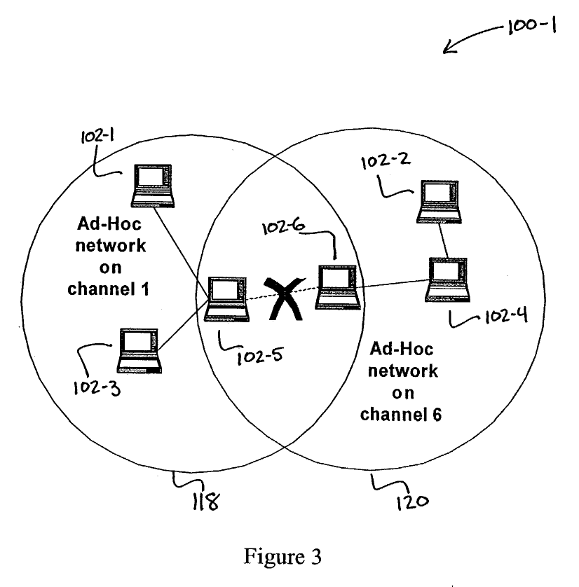

The ad-hoc network 100 of FIG. 1 may be divided between communication channels to illustrate the need for a communication bridge, as shown in network 100-1 of FIG. 3. FIG. 3 is a block diagram of an example of a conventional 802.11 ad-hoc network in which radios operating on one channel are unable to communicate with radios operating on another channel. As illustrated, the network 100-1 is an 802.11 network, and includes a plurality of terminals 102-1 through 102-6 (referred to generally as terminals or nodes 102), which are 802.11 terminals (which can also be referred to as 802.11 radios). In the arrangement shown in FIG. 3, nodes 102-1, 102-3 and 102-5 are using channel 1 to communicate with each other and are shown within an area bounded by 118. Nodes 102-2, 102-4 and 102-6 are using channel 6 to communicate with each other and are shown within a communication area bounded by 120. The closed areas 118 and 120 are presented as examples to define the nodes occupying each channel. In actual network distributions, these areas can be separate as shown, or fully overlap, and no actual boundary for either channel, other than RF communication ranges, actually exist.

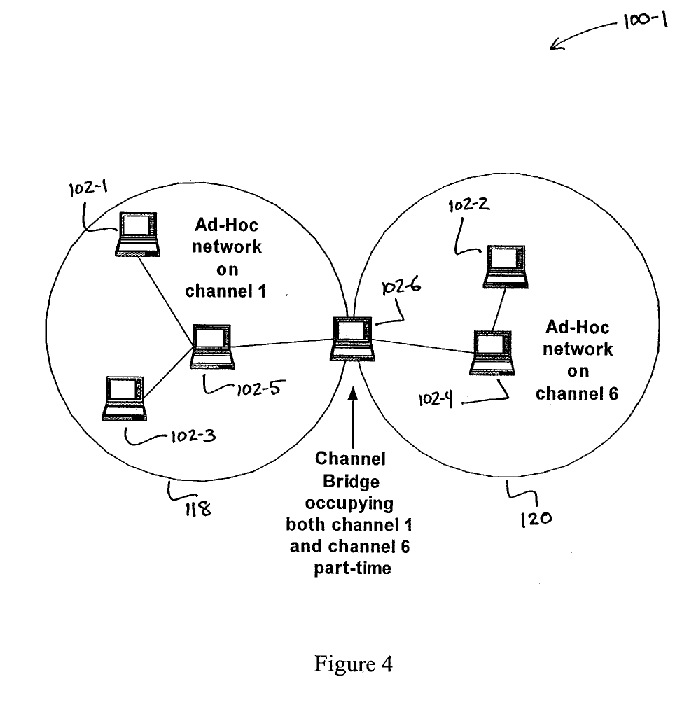

However, as shown in FIG. 4, node 102-6 can operate as a “channel bridge” node, occupying both channel 1 and channel 6, at least part-time, for purposes discussed in more detail below. Details regarding “bridging nodes” are also discussed in a new nonprovisional U.S. patent application of William Vann Hasty Jr. entitled “A System and Method for Seamlessly Bridging Between an 802.11 Infrastructure and an 802.11 Ad-Hoc Routing Network Using a Single Transceiver”, attorney docket no. 43695, the entire content being incorporated herein by reference.

FIG. 4 is a block diagram of an 802.11 ad-hoc network employing an embodiment of the present invention which creates a channel bridge that can occupy multiple channels on at least a part-time basis to enable the delivery of traffic across channels. As can be appreciated by one skilled in the art, the nodes 102-1 through 102-6 can be stationary or mobile, and are. configured to communicate with each other using packetized signals which can include voice, data or multimedia. Additionally, any node can be used to function as a channel bridge node, and node 102-6 is merely presented as the bridge in FIG. 4 as one example of an embodiment of the present invention.

The embodiment of the present invention shown in FIG. 4 enables an 802.11 node 102 participating in an ad-hoc routing network 100 to periodically leave its home channel (e.g., terminal 102-1 can leave channel 1) to search for routes (i.e., listen passively for routing advertisements) on other channels, and to issue its own routing advertisements to 802.11 nodes 102 currently listening on its home channel. Along with the routing information, the home channels for each destination and route are advertised. Thus, when a route for a destination residing on a non-home channel is needed, the node 102 may switch channels, deliver the traffic, and return to its home channel. The embodiment of the present invention can thus increase the bandwidth capacity for an 802.11 ad-hoc routing network by a factor approaching a multiple of three. Moreover, although the above embodiment is described specifically in regards to the 802.11 Medium Access Protocol (MAC), the embodiment may be employed in other types of networks.

To achieve the channel switching capabilities described above, the embodiment of the present invention directs a node, such as node 102-6 in the example shown in FIG. 4, to act as a channel bridge, which can occupy multiple channels, such as both channels 1 and 6 at least part-time, to deliver traffic across channels.

The channel bridge (CB) node of an embodiment of the present invention can occupy multiple channels in series, wherein the time spent on each channel is called the CB_DwellTime, and the set of channels a channel bridge can occupy is known as the CB_ChannelSet. The CB node begins operation on the first channel in its CB_ChannelSet and advertises its presence with a special routing advertisement identifying its CB_ChannelSet, CB_DwellTime, and all of the routes to destinations on all channels in the CB_ChannelSet, excluding destinations on the current channel, to the other ad-hoc routing nodes, or radios, in the network. This special CB routing advertisement from the CB node is known as the CB_Advert.

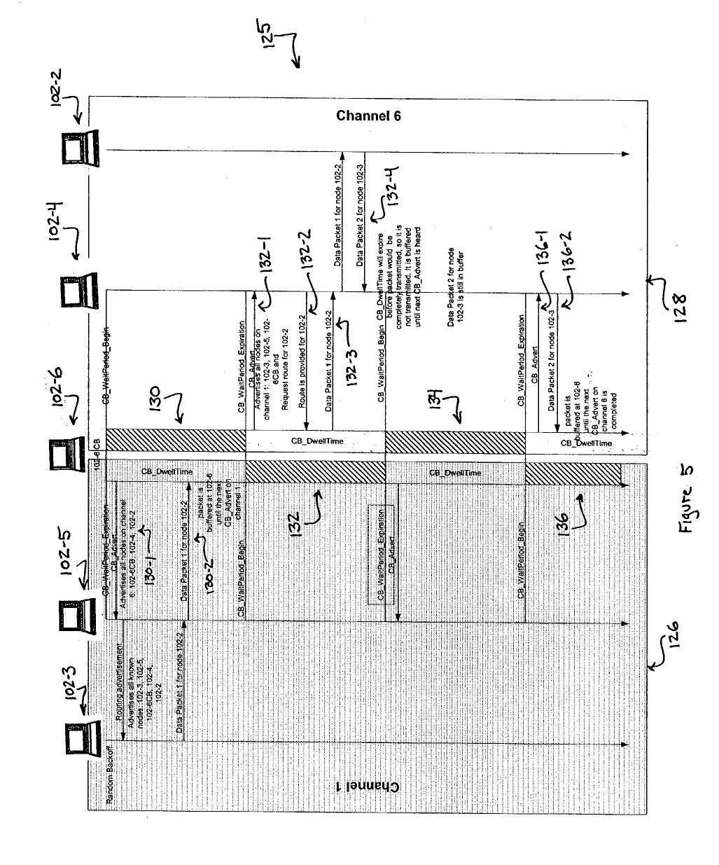

Remaining nodes within RF communication range of the CB node will receive such a CB_Advert while on the channel the CB node is currently occupying. After receipt of the CB_Advert and the expiration of a random wait period CB_WaitPeriod, all non-CB ad-hoc routing nodes can attempt to deliver any traffic destined for a node on another supported channel that has been buffered to the CB node. The non-CB ad-hoc routing nodes can communicate this traffic to the CB node for a period of time not exceeding the CB_DwellTime, at which time, the CB node moves to the next channel. All of this received traffic is buffered in the CB node until it changes to the destination channel for delivery. At the expiration of the CB_DwellTime, the CB node changes channels to the next channel in the CB_ChannelSet and attempts to deliver all buffered traffic destined for the newly occupied channel. In FIG. 5, a simple communication between the separate channels of FIG. 4 is shown.

In FIG. 5, a flow chart is shown illustrating an example of the operation of a channel bridge node to occupy and deliver traffic across multiple channels, such as both channels 1 and 6 of FIG. 4. In FIG. 5, the flow chart 125 illustrates the sequential operation of one example of the nodes of FIG. 4 in a channel bridging operation. In flow chart 125, the operations of the nodes of area 118 of FIG. 4 are shown in the left flow chart portion 126. These include operations of nodes 102-1, 102-3 and 102-5, which are using channel 1 to communicate with each other and other nodes. The operations of the nodes of area 120 of FIG. 4 are shown in the right flow chart portion 128. These include operations of nodes 102-2 and 102-4, which are using channel 6 to communicate with each other and other nodes. Operations of node 102-6, the CB node, is shown in both left and right flow chart portions, as the CB node 102-6 serves to occupy and deliver traffic across both channels 1 and 6.

As shown in FIG. 5, the CB node 106 alternates between a CB_DwellTime in 126, and an identical a CB_DwellTime in 128. In the example shown, the CB node occupies 126 for a first CB_DwellTime 130. During this CB_DwellTime 130, a CB_WaitPeriod expiration is followed by a CB_Advert message as described above at 130-1. The CB_Advert includes the special CB routing advertisement from the CB node which advertises its presence and identifies its CB_ChannelSet, CB_DwellTime, and all of the routes to destinations on all channels in the CB_ChannelSet, excluding destinations on the current channel, to the other nodes in the network. During the CB_DwellTime 130, node 102-3 is shown receiving the CB_Advert, and having a data packet destined for node 102-2, routes the data packet to CB node 102-6 via node 102-5, and the data packet is buffered at 102-6 until the next CB_Advert at 130-2.

During the CB_DwellTime 130, a CB_WaitPeriod is begun in 128. Upon completion in 126 and CB_DwellTime 130, CB_DwellTime 132 begins in 128 and shortly after a CB_WaitPeriod expiration, a CB_Advert message is sent which, in addition to the information described above, further includes a request for routes to deliver packets buffered with destinations within 128 at 132-1. In this example therefore a route to node 102-2 is requested. Once a route is provided at 132-2, the packet can be communicated to node 102-2 at 132-3. In the example shown in FIG. 5, node 102-2 then replies with a packet to node 102-3 at 132-4, however, there is insufficient time in CB_DwellTime 132 to deliver the packet to CB 102-6, therefore the packet is not transmitted and is buffered until the next CB_Advert is heard in 128.

A subsequent CB_DwellTime 134 in 126 is shown following CB_DwellTime 132 in 128. For illustration purposes, no further packets are shown received during CB_DwellTime 134, however any number of additional packets can be received for routing. In a following CB_DwellTime 136 in 128, after a CB_WaitPeriod expiration, a CB_Advert message is sent at 136-1 and the CB node 102-6 then receives the packet for node 102-3 from node 102-2 via node 102-4. The data packet is buffered at 102-6 until the next CB_Advert in 126 at 136-2. In a similar fashion, if during CB_DwellTime 132, the CB node 102-6 did not have sufficient time to deliver the packet to node 102-2 after requesting and receiving a route to 102-2, the packet can be buffered at 102-6 until the next CB_Advert in 128.

In the embodiment of the present invention, 802.11 control packets, such as RTS, CTS and ACK, are delivered using normal 802.11 delivery rules. In this case, RTS (i.e. directed packets) should not be directed to the channel bridge if the accompanying data packet transmission duration is longer than the amount of time left on the CB_DwellTime for the channel. These packets are buffered until the next CB_Advert is heard on the channel from the bridge node and the CB_DwellTime at a maximum possible value. The CB_DwellTime period should be greater than the maximum duration time on a channel for a maximum transmission unit sized packet. After all pending traffic has been delivered, the CB_Advert is issued on the current channel and the CB_DwellTimer begins a new dwell period on the channel.

As shown in FIGS. 3 and 4, each 802.11 node 102 utilizes a routing protocol that periodically advertises routes for destinations to all other nodes in the routing network. Without a channel bridge, two separate groups of ad-hoc routing nodes 102 form two separate routing networks 118 and 120 (i.e., one using channel 1 and the other using channel 6 as shown in FIG. 2). When a channel bridge node is present, the two routing networks 118 and 120 are no longer separate, and become a single routing network.

Although only a few exemplary embodiments of the present invention have been described in detail above, those skilled in the art will readily appreciate that many modifications are possible in the exemplary embodiments without materially departing from the novel teachings and advantages of this invention.

What is claimed is:

1. A method for controlling data transmission using a channel bridge for routing data traffic between channels in a wireless communications network, said network including a plurality of nodes being adapted to transmit and receive signals to and from other nodes in said network, the method comprising:
configuring a first node of said network to communicate via a plurality of communication channels, and identifying said first node as a channel bridging node;
controlling at least one node of said network to detect said first node as a channel bridging node, and to communicate data traffic requiring routing between a first and second communication channel of said plurality to said first node; and
controlling said first node to receive said data traffic via said first communication channel, and to transmit said data traffic to a destination via said second communication channel.

2. A method as claimed in claim 1, further comprising:
controlling said first node to create a routing advertisement; and
identifying said first node as said channel bridging node by communicating said routing advertisement in each communication channel of said plurality.

3. A method as claimed in claim 2, wherein said routing advertisement includes a channel set which identifies at least one communication channel of said plurality.

4. A method as claimed in claim 3, wherein said routing advertisement includes a dwell time which identifies a period during which said first node can communicate via said communication channel.

5. A method as claimed in claim 3, wherein said routing advertisement includes a destination route set which identifies at least one destination route of said communication channel.

6. A method as claimed in claim 1, further comprising:
controlling said at least one node of said network to detect said first node as a channel bridging node between said first and second communication channels.

7. A method as claimed in claim 1, further comprising:
controlling said at least one node of said network to communicate said data traffic requiring routing between said first and second communication channels to said first node via said first channel and controlling said first node to detect a destination for said data traffic requiring transmission via said second channel.

8. A method as claimed in claim 1, further comprising:
controlling said first node to buffer said data traffic requiring routing between said first and second communication channels until said first node is configured to communicate via said second channel.

9. A method as claimed in claim 1, further comprising:
configuring said first node of said network to communicate via each communication channel of said plurality in series.

10. A method as claimed in claim 1, wherein said first and second communication channels are the same.

11. A system for controlling data transmission using a channel bridge for routing data traffic between channels in a wireless communications network, said network including a plurality of nodes being adapted to transmit and receive signals to and from other nodes in said network, the system comprising:
at least one node, adapted to detect a first node as a channel bridging node, and to communicate data traffic requiring routing between a first and second communication channel of a plurality to said first node;
said first node, adapted to communicate via said plurality of communication channels, and being adapted to communicate an identity as a channel bridging node; and
said first node being further adapted to receive said data traffic via said first communication channel, and to transmit said data traffic to a destination via said second communication channel.

12. A system as claimed in claim 11, wherein:
said first node is adapted to create a routing advertisement, and to communicate said identity as a channel bridging node by communicating said routing advertisement in each communication channel of said plurality.

13. A system as claimed in claim 12, wherein said routing advertisement includes a channel set which identifies at least one communication channel of said plurality.

14. A system as claimed in claim 13, wherein said routing advertisement includes a dwell time which identifies a period during which said first node can communicate via said communication channel.

15. A system as claimed in claim 13, wherein said routing advertisement includes a destination route set which identifies at least one destination route of said communication channel.

16. A system as claimed in claim 11, wherein:
said at least one node is adapted to detect said first node as a channel bridging node between said first and second communication channels.

17. A system as claimed in claim 11, wherein:
said at least one node is adapted to communicate said data traffic requiring routing between said first and second communication channels to said first node via said first channel; and
said first node is adapted to detect a destination for said data traffic requiring transmission via said second channel.

18. A system as claimed in claim 11, wherein:
said first node is adapted to buffer said data traffic requiring routing between said first and second communication channels until said first node is configured to communicate via said second channel.

19. A system as claimed in claim 11, wherein:
said first node is adapted to communicate via each communication channel of said plurality in series.

20. A system as claimed in claim 11, wherein said first and second communication channels are the same.

21. A computer-readable medium of instructions, adapted to control data transmission using a channel bridge for routing data traffic between channels in a wireless communications network, said network including a plurality of nodes being adapted to transmit and receive signals to and from other nodes in said network, comprising:
a first set of instructions, adapted to configure a first node of said network to communicate via a plurality of communication channels, and to identify said first node as a channel bridging node;
a second set of instructions, adapted to control at least one node of said network to detect said first node as a channel bridging node, and to communicate data traffic requiring routing between a first and second communication channel of said plurality to said first node; and
a third set of instructions, adapted to control said first node to receive said data traffic via said first communication channel, and to transmit said data traffic to a destination via said second communication channel.

22. A computer-readable medium of instructions as claimed in claim 21, wherein:
said first set of instructions is adapted to control said first node to create a routing advertisement; and
said first set of instructions being further adapted to identify said first node as said channel bridging node by communicating said routing advertisement in each communication channel of said plurality.

23. A computer-readable medium of instructions as claimed in claim 22, wherein said routing advertisement includes a channel set which identifies at least one communication channel of said plurality.

24. A computer-readable medium of instructions as claimed in claim 23, wherein said routing advertisement includes a dwell time which identifies a period during which said first node can communicate via said communication channel.

25. A computer-readable medium of instructions as claimed in claim 23, wherein said routing advertisement includes a destination route set which identifies at least one destination route of said communication channel.

26. A computer-readable medium of instructions as claimed in claim 21, wherein:
said second set of instructions is adapted to control said at least one node of said network to detect said first node as a channel bridging node between said first and second communication channels.

27. A computer-readable medium of instructions as claimed in claim 21, wherein:
said second set of instructions is adapted to control said at least one node of said network to communicate said data traffic requiring routing between said first and second communication channels to said first node via said first channel; and
said third set of instructions is adapted to control said first node to detect a destination for said data traffic requiring transmission via said second channel.

28. A computer-readable medium of instructions as claimed in claim 21, further comprising:
a fifth set of instructions, adapted to control said first node to buffer said data traffic requiring routing between said first and second communication channels until said first node is configured to communicate via said second channel.

29. A computer-readable medium of instructions as claimed in claim 21, further comprising:
configuring said first node of said network to communicate via each communication channel of said plurality in series.

30. A computer-readable medium of instructions as claimed in claim 21, wherein said first and second communication channels are the same.
